(19) United States
(12) Patent Application Publication
(10) Pub. No.: US 2010/0257241 A1
(43) Pub. Date: Oct. 7, 2010

(54) System and method for adaptive delivery of electronic comminucations

(75) Inventors: Mark Hale, San Jose, CA (US); Richard Berry, Brisbane, CA (US)

Correspondence Address: Dr. Mark Hale;Demandforce, Inc, Suite 600, 425 Second Street, San Francisco, CA, 94107, US

(73) Assignee: Demandforce, Inc., San Francisco, CA (US)

(21) Appl. No.: 12/384,285

(22) Filed: Apr. 2, 2009

(51) Int. Cl. G06F 15/16

(52) U.S. Cl. 709/206

(57) ABSTRACT

This document describes a system and method for adapting delivery of electronic communications. It increases the reliability of electronic message delivery by learning from message and server behavior to determine which channel should be used for future message delivery. This is done to increase likelihood of communications delivery to recipients of electronic communications.

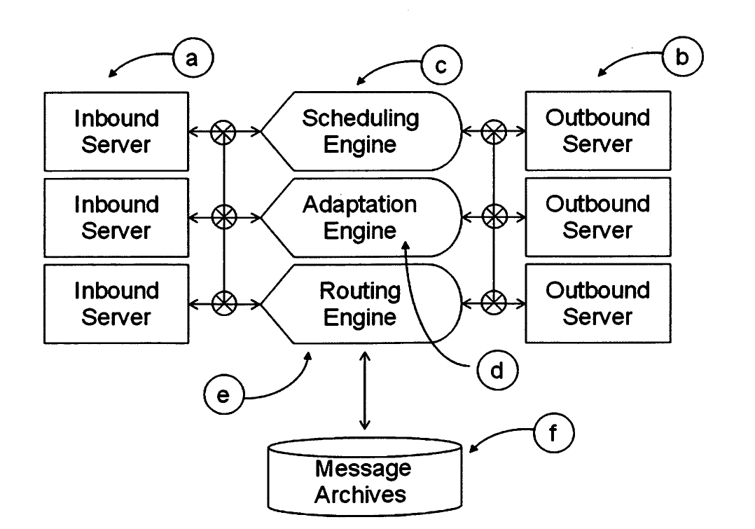

### RELATED APPLICATIONS

1. U.S. Pat. No. 5,959,543, “Two-way wireless messaging system with flexible messaging,” Sep. 28, 1999.
2. U.S. Pat. No. 5,742,668, “Electronic massaging network,” Apr. 21, 1998.
3. U.S. Pat. No. 7,043,262, “A two-way pager for communicating over a Global System for Mobile Communications (GSMGPRS) network,” May 9, 2006.
4. U.S. Pat. No. 6,073,165, “Filtering computer network messages directed to a user's e-mail box,” Jun. 6, 2000
5. U.S. Pat. No. 6,182,118, “System and method for distributing electronic messages in accordance with rules,” Jan. 30, 2001
6. Patent # US 2006/0253537 A1, “A method and system for providing rules-based or algorithms based automated response optimization,” May 2, 2006
7. U.S. Pat. No. 6,438,583, “System and method for re-routing of e-mail messages,” Jun. 23, 1999.
8. CAN-SPAM Act of 2003, Pub. L. No. 108-187, 117 Stat. 2699 (2003)
9. U.S. Pat. No. 6,421,709, “E-mail filter and method thereof,” Jul. 7, 1999.

### BACKGROUND OF THE INVENTION

1. Field of Invention

Electronic communications are becoming increasingly more widespread with new devices and services becoming routinely available to both consumers and businesses. For example, it is not uncommon for businesses to send out emails regarding upcoming appointments. It is important that these messages reach their intended recipients to get the best customer care possible. It is therefore important that the invention adapts to communications with the business recipients to optimize delivery performance.

2. Brief Description of Background Art

The present invention employs the Wireless Message Protocol v.3.0 as maintained by the Open Mobile Alliance (Apr. 24, 2006).

The present invention employs the MIME specification described by the IETF in the RFC 2045—Multipurpose Internet Mail Extensions (MIME) Part One: Format of Internet Message Bodies (Nov. 1996).

3. Description of the Prior Art

Electronic communications is widespread among consumers and has resulted in the proliferation of handheld devices, including cell phones, personal data assistants, laptops and others. This body of work focuses specifically how businesses increase delivery reliability to its customers.

There are many forms of communication formats such as Email, Text Messaging, Instant Messaging, among others. For instance, in the cases that a company would like to send text messages to their customers, they may obtain access directly from a cell phone carrier (for example Verizon, Sprint, T-Mobile and other carriers) or a broker (such as OpenMarket) to access the carrier network. They then use established techniques described in U.S. Pat. No. 5,959,543 for messaging, U.S. Pat. No. 5,742,668 for the network, and U.S. Pat. No. 7,043,262 for the gateway. Much of this network and ancillary operations are provided by the carriers and access is through a simple WMP gateway.

It is fairly common to filter communications, such as using a spam filter, and these inventions utilize filtering as well U.S. Pat. No. 6,073,165 and U.S. Pat. No. 6,182,118. The invention utilizes these common filtering mechanisms but relies on the new concept of sequencing based on metadata properties found on the network to do that.

Patent # US 2006/0253537 A1 seeks to improve mail delivery by modifying email content. The system and method of the invention described in this patent application seeks to do so without requiring content modification. U.S. Pat. No. 6,438,583 reroutes based on failed delivery alone to a new designated server.

The CAN_SPAM Act of 2003 is a safeguard to protect consumers from unwarranted email and is targeted at the senders. U.S. Pat. No. 6,421,709 is an example of a email filtering program that provides an implementation in software on consumer sites. This is relevant because the system and method of the invention seeks to improve deliverability and adhere to compliance with the Act and respect the domain of software implementations to protect consumers from unwanted emails.

### SUMMARY OF THE INVENTION

The subject of the invention is to use common forms of electronic communications, such as email, but to learn sending patterns to increase delivery reliability. The example cited earlier describes how a dental office desires to email many patients but does not want to jeopardize delivery because a particular patient has flagged them as ‘SPAM’.

Other reasons a mail carrier would flag the communications as ‘SPAM’ would be because of incorrectly spelled email addresses (also known as bounce email), incorrect recipients (also known as bounce email) and repeated attempts, among others. It is desirable for an email engine to scan for potentially deficient recipients of electronic messages and to re-route them.

What the system and method of the invention does is learn from historical communications patterns to optimize delivery routing via specified outbound communications servers and across protocols. It does so by incorporating adaptive learning methods to learn from previous communications, a routing engine with methods to discern which delivery to use and a scheduler to queue communications. This is where the system of the invention differs from prior art in that it optimizes outbound message server to deliver communications.

### BRIEF DESCRIPTION OF THE DRAWING

The drawing illustrates the system of the invention. Electronic communications are received at a plurality of inbound communication servers (a) and sent with a plurality of outbound communication servers (b). The scheduling engine (c) is responsible for the receipt and queuing of communications. The adaptation engine (d) is responsible for learning from the previous and queued communications. The routing engine (e) is responsible for all routing of inbound and outbound email through the system including interfacing with the message archives (f).

### DETAILED DESCRIPTION OF THE INVENTION

This is a detailed description of the system and method for adaptive delivery of electronic communications. The premise of the system of the invention is that entities, individual or businesses, interact with communications in the form of email, text messages, instant messages, letters and so forth from a plurality of possible devices. The system is designed such that it optimizes the delivery of communications to the recipient.

What makes the system of the invention unique is that it contains methods for adapting its scheduled delivery of communications to optimize delivery likelihood to its recipient. As an example, consider a dentist practice that communicates with email to their patients. The practice may communicate with the patient about upcoming appointments using an appointment confirmation reminder. This is considered an important communication and it is imperative the patient receive the communication concerning their treatment. The practice may also send out monthly newsletters highlighting new treatments that are now available or discuss preventative care. These communications are not considered to be directly related to the patient's care and, therefore, deliverability is less critical. The system and method of the invention seeks to adapt from the delivered message so that the failed delivery of the newsletter does not impede delivery of the appointment confirmation reminder.

The system of the invention acts as an intermediary that can initiate or receive electronic communications from a plurality of inbound communications servers shown in the drawing at (a) or outbound communications as shown in the drawing at (b). The separation is shown for clarity but the implementation may be on one or more physical servers or application layers or protocols.

Communications is done through any number of standard communication protocol or gateways. For example, a text message may be received from a user via a dedicated short code. An email may be received through a specified email address defined in an email gateway. Each inbound and outbound communication server in the plurality has a uniquely defined electronic address which will be used in the adaptation engine at (d) and described in more detailed in subsequent paragraphs.

The scheduling engine (c) is responsible for the generation of all communications that live in the system of the invention. It manages new electronic messages that are delivered via the outbound communication servers at (b). These communications may be text messages, emails and other electronic messages. They may be generated from software applications, email clients, handheld devices and other interface. Communications are stored in the message archives at (f) in a file or database storage scheme.

The adaptation engine (d) monitors the inbound and outbound messages and the queue. Its function is to mark the outbound communications server to be used for delivery. The adaptation engine will then identify the communications server for delivery. Delivery is a tuple of three parameters:
The recipients address (email, mobile number, etc).
The outbound communications server identifier which is an IP address for a mail server and a short code for a text messages
The category of the communication which is an enumerated list of types such as standard, promotion, reminder, referral, and welcome.
   The recipient address and category are known functions of the scheduling engine (c). The inclusion of category allows for the message content to be prescribed rather than inferred from content matching algorithms as found in other inventions. Categories are allowed to have user-defined weights to prioritize the deliverability. For instance, a confirmation reminder email is more important that a custom promotion email since the former is critical for upcoming services to be rendered.

The key parameter in the adaptation engine tuple is the outbound communication server as it is the interface for successful delivery because system and method of the invention does not propose to modify the content of the communication but rather increase its deliverability via the communication servers. Therefore, the adaptation engine tracks messages for the following interactions to discern future communication server for delivery:
Minimize soft or hard bounce on the outbound communication servers per recipient address, recipient domain and communication category
Minimize bounce on the inbound communication servers per recipient address, recipient domain and communication category
Process and feedback messages returned in the inbound communication server per recipient address and insure that no future message combinations of recipient address, server and category are permitted
Monitor queue size in the message archives on recipient domain and balance outbound communication server to minimize domain traffic
Monitor message history in archives on recipient address and domain and balance outbound communication server to minimize domain traffic
Monitor uptime and load of inbound and outbound communication servers across recipient domains
Monitor communication formats such as email and text messages to utilized deliverability preferences across formats, for example an opt out of text message would slow down email deliverability until a pattern of successful delivery can be established
   Each of these parameters can be modified for individual business needs with user definable thresholds ranging from on to off with varying degrees of application. Considering these factors, the adaptation engine (d) selects a server from the plurality of outbound communication servers is selected for delivery by the routing engine (e).

The routing engine (e) is responsible for transferring the outbound communications from the message archive (f) to the plurality of outbound communications servers (b) for as determined by the adaptation engine (d) for optimal delivery. The routing engine does this by establishing an interface to the communication servers using any established gateways and protocols (eg smtp for email).

The final message is considered to be delivery optimized and to have the highest likelihood of reaching the intended recipient.

1. A Delivery system for sending electronic communications, comprising:
a message queue and archive;
a plurality of mail servers;
an adaptation engine;
a routing engine;
a scheduling engine;

2. The Delivery system of claim 1, further comprising of a method for scheduling communications

3. The Delivery system of claim 1, further comprising of a method for learning routing paths from the plurality of messages using omni-directional comparators

4. The method of claim 3 further allowing for user definable thresholds

5. The Delivery system of claim 1, further comprising of a method for routing communications
